(19) United States
(12) Patent Application Publication
(10) Pub. No.: US 2002/0017430 A1
(43) Pub. Date: Feb. 14, 2002

(54) Utility tray

(76) Inventor: Michael Scot Rosko, Greenwood, IN (US)

Correspondence Address: BARNES & THORNBURG, 11 SOUTH MERIDIAN, INDIANAPOLIS, IN, 46204

(21) Appl. No.: 09/906,527

(22) Filed: Jul. 16, 2001

Related U.S. Application Data
(60) Provisional application No. 60/224,489, filed on Aug. 11, 2000.

(51) Int. Cl. E06C 5/32

(52) U.S. Cl. 182/129; 248/238

(57) ABSTRACT

A utility tray for a step stool includes a front portion, a rear portion, and opposing side portions. A tray mount is coupled to the front portion for movably mounting the tray to the step stool. In one embodiment a service cord mount is coupled to the tray and is configured to receive an extension cord or similar object wrapped about the cord mount. In another embodiment, the tray includes a compartment for retaining objects and a lid to close the compartment. In another embodiment the tray includes a trough having a bottom providing a longitudinally extending slot.

This application claims priority under 35 U.S.C. § 119(e) to U.S. Provisional Application Serial No. 60/224,489 filed Aug. 11, 2000, which is expressly incorporated by reference herein.

The present invention relates to a utility tray to be movably coupled to a step stool.

According to the present disclosure, a utility tray for a step stool is provided comprising a monolithic body molded to have a front portion, a rear portion, and opposite side portions. A tray mount is coupled to the rear portion for movably mounting the tray to the step stool. A cord mount is coupled to the front portion of the tray and is configured to receive an extension cord or similar object wrapped about the cord mount.

In an illustrative embodiment, one of the opposite sides includes a compartment for retaining objects. The utility tray includes a hinged lid to close the compartment. In one embodiment, the lid and utility tray are monolithic. The lid illustratively includes a latch to engage an aperture in the upwardly facing surface of the utility tray to releasably close the compartment.

In another illustrative embodiment, the cord mount includes opposite L-shaped extensions projecting forwardly from the utility tray, and each extension defines a recess into which the loops of the cord are inserted.

In another illustrative embodiment, the utility tray includes a trough extending along one of the opposite sides. The trough includes a bottom providing a longitudinally extending slot to communicate between the tray's upwardly and downwardly facing surfaces to retain, for example, a putty knife.

In still other illustrative embodiments, other features such as holes, recesses and receptacles are provided in the monolithic body of the utility tray. Such features have varying shapes and sizes to accommodate articles of similar varying shapes and sizes.

Additional features of the present invention will become apparent to those skilled in the art upon consideration of the following detailed description of the invention exemplifying the best mode of carrying out the invention as presently perceived.

### BRIEF DESCRIPTION OF THE DRAWINGS

The detailed description particularly refers to the accompanying figures in which:

FIG. 1 is a perspective view of a utility tray coupled to an illustrative step stool in an opened use position in accordance with the present invention;

FIG. 2 is a front side elevation view of the utility tray of FIG. 1, showing the utility tray and step stool in a closed storage position;

FIG. 3 is a perspective view of the upwardly facing surface of the utility tray;

FIG. 4 is a perspective view of the downwardly facing surface of the utility tray of FIG. 3;

FIG. 5 is a partial perspective view showing a hinged lid to close a compartment, the lid having a latch;

FIG. 6 is a partial perspective view of the utility tray of FIG. 3 showing the lid including an alternative embodiment the latch;

FIG. 7 is a perspective view of the utility tray of FIG. 3; and

FIG. 8 is a partial perspective view of a clamp for holding an end of an extension cord.

### DETAILED DESCRIPTION OF THE DRAWINGS

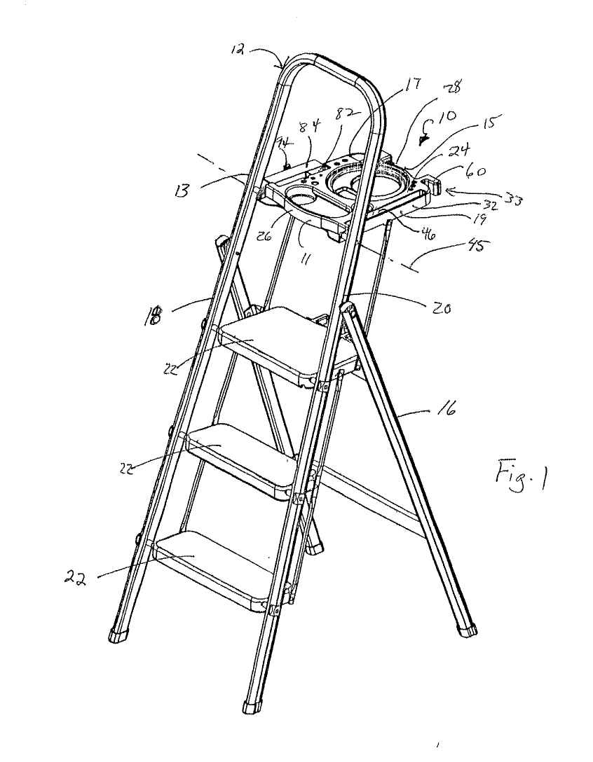

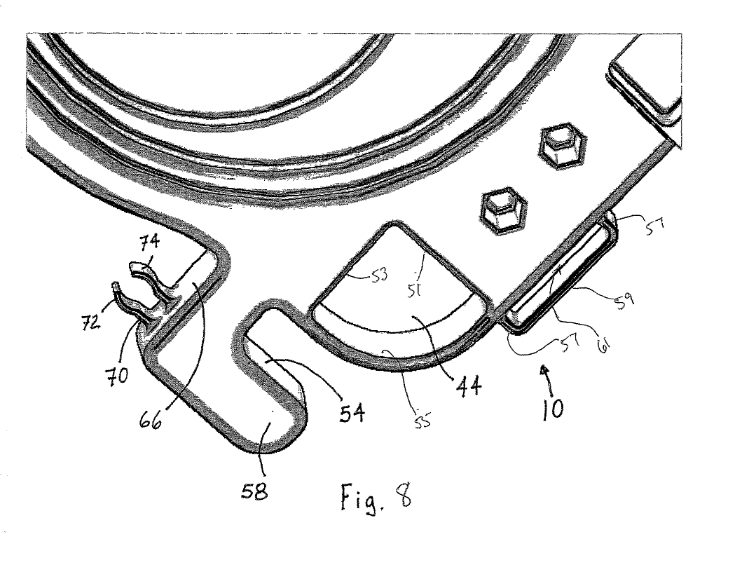

As shown in FIGS. 1-8, a utility tray 10 having a monolithic body is movably coupled to a step stool 12. Utility tray 10 includes an upwardly facing surface or upper side 24, a downwardly facing surface or lower side 25, a rear portion 11 providing a rear edge 26, a front portion 15 providing a front edge 28, a first or left side or side portionl7 providing a first or left edge 30, and a second or right side or side portion 19 providing a second or right edge 32. Illustratively, utility tray 10 also includes receptacles 34, 35, 36, 37, 38, and 39.

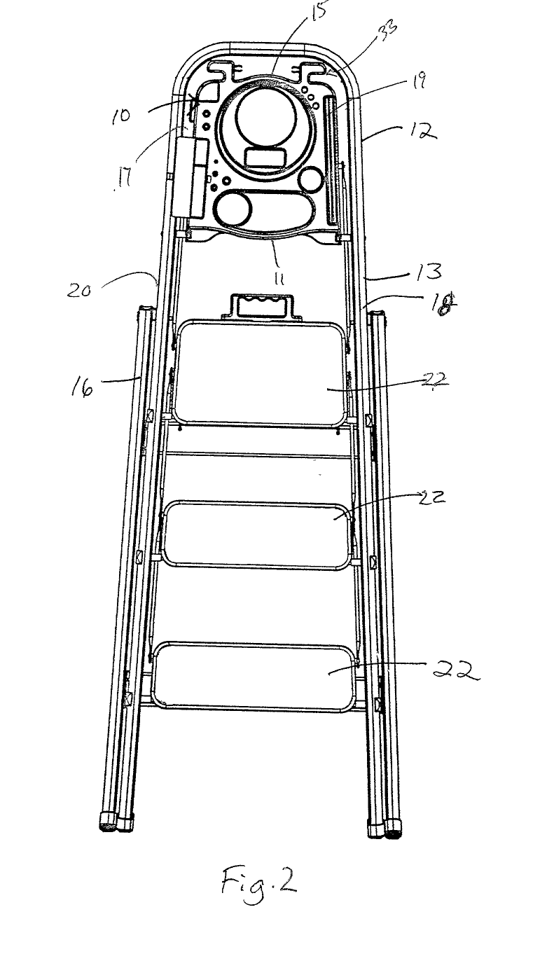

The utility tray 10 is pivotably coupled to a step stool 12 as shown, for example, in FIG. 1. As shown in FIGS. 1, 2 & 7, utility tray 10 is coupled to a step stool 12 having a frame 13 including transversely spaced apart mounting portions 18, 20 a rear leg 16, and steps 22.

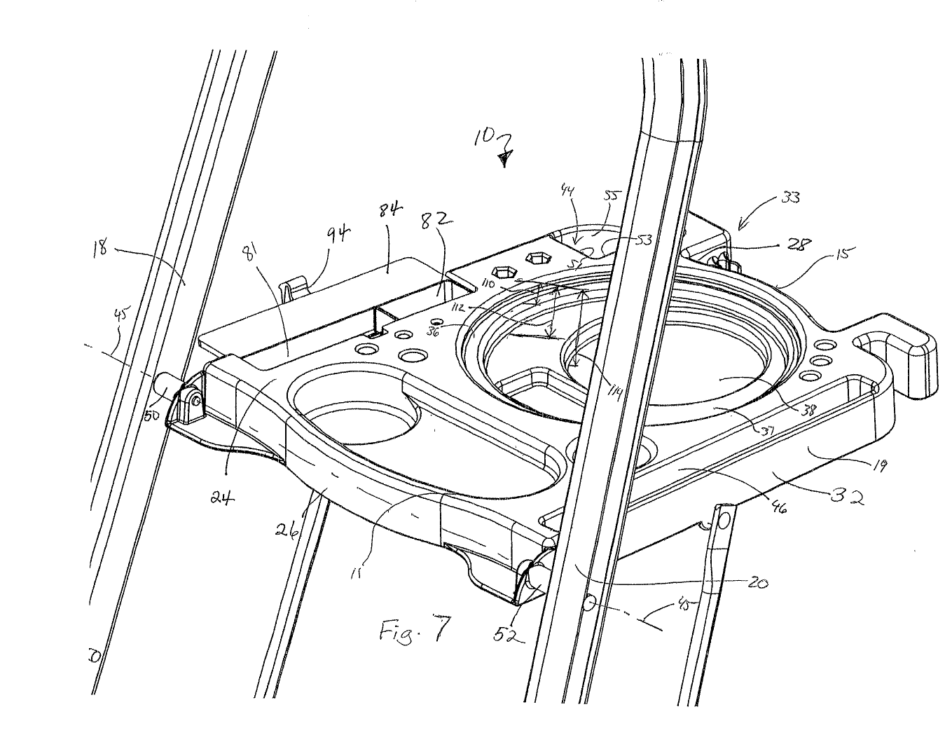

As best shown in FIG. 7, rear portion 11 includes a tray mount 31 for movably coupling tray 10 to step stool 12. Tray mount 31 includes opposing mount members or connecting pins 50, 52 positioned on the rear edge 26 to lie in a spaced-apart relationship. Step stool 12 provides spaced apart mounting posts 41, 43 to receive connecting pins 50, 52 for pivotably coupling utility tray 10 to step stool 12 for movement about a horizontal axis 45 adjacent rear portion 11.

As best shown in FIGS. 1, 3, and 8, utility tray 10 includes a service cord mount 33 for receiving, for example, a wound up service or extension cord, rope, wire, or similar object. Cord mount 33 includes spaced apart transversely extending recesses 54, 56 defined by L-shaped extensions 58, 60. Cord mount 33 includes first clamp 70 coupled to extension 58 and second clamp 76 coupled to extension 60. First and second clamps 70, 76 project toward each other and are adapted to hold, for example, cord ends, rope, wire, and the like.

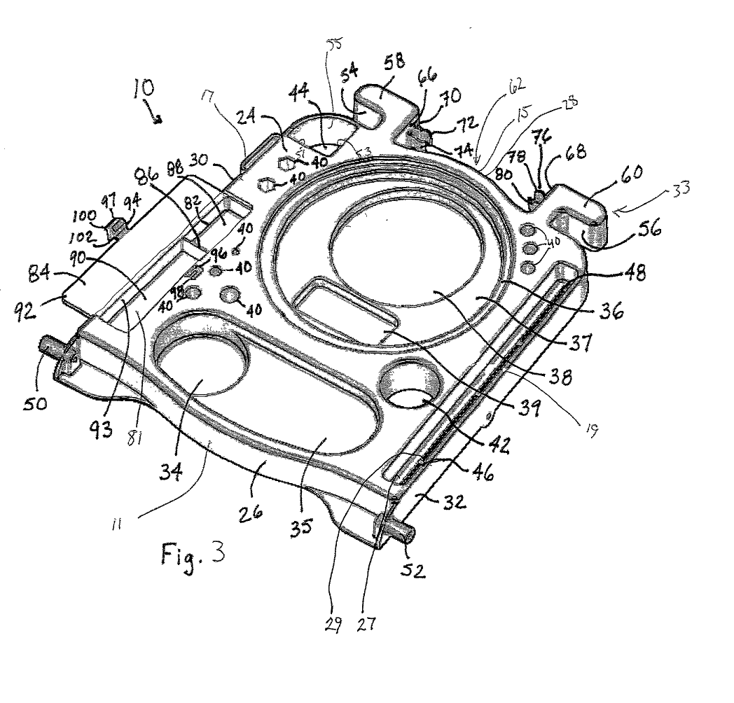

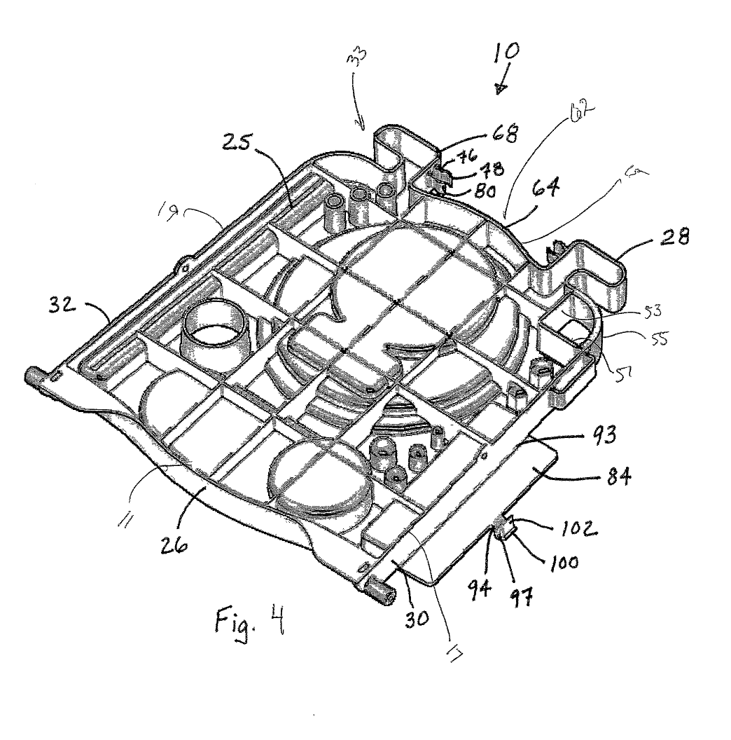

As shown in FIGS. 3 and 4, an opening or slot 62 is positioned to lie between extensions 58, 60. Opening 62 is defined by a wall 64 of front portion 15 and opposing side walls 66, 68 of extensions 58, 60. Side wall 66 includes first clamp 70 having clamp portions 72, 74 which are formed as a mirror image of each other. Side wall 68 includes second clamp 76 having clamp portions 78, 80 which are similarly shaped in a mirror image of each other. Clamps 70 and 76 are positioned to lie in a spaced apart and opposing relationship. First clamp 70 and second clamp 76 are used to hold ends of an extension cord, wire, rope, and the like. In use, an extension cord or similar object may be inserted into either of clamps 70, 76 by inserting the cord between the associated clamp portions. The associated clamp portions cooperate to releasably retain or “pinch” the cord or similar object in position until a user removes the cord from the clamp.

As shown in FIGS. 3-4 and 7, utility tray 10 also includes a compartment 82 adjacent one of the opposite side portions 17, 19, illustratively shown adjacent side portion 17, near left edge 30. Compartment 82 provides a recess 81 in upwardly facing surface 24 and includes first and second sub-compartments 88, 90 for holding items, such as, for example, nuts, bolts, money, jewelry, and the like. Utility tray 10 includes a lid 84 movably mounted to tray 10 to close compartment 82. Lid 84 has latch 94 which engages latch aperture 96 to releasably secure lid 84 to cover compartment 82.

In one embodiment, lid 84 is monolithic with tray 10 and is coupled to upwardly facing surface 24 to pivot between an opened position and a closed position or a position closing recess 81. Compartment 82 illustratively includes a dividing wall 86 which separates first and second sub-compartments 88, 90. First and second sub-compartments 88, 90 are sized to hold various items, including, but not limited to, jewelry, money, nuts, bolts, washers, and the like.

Lid 84 has a perimeter rim 92 and a hinged side 93. Latch 94 is coupled to and extends outwardly from perimeter rim 92. Lid 84 is illustratively pivotably coupled to upwardly facing surface 24 of tray 10 about an axis 47 extending along hinged side 93. Upwardly facing surface 24 provides a latch aperture 96 positioned to receive latch 94 for releasably closing compartment 82. Latch aperture 96 includes opposing interior side walls 98 to engage latch 94 and releasably retain latch 94 in the closed position. Although lid 84 has sometimes been described herein as being hinged to tray 10, it is with the scope of this disclosure to provide tray 10 without lid 84 or to movably couple lid 84 to tray 10 in other known manners to permit a user to close compartment 82. For example, the lid 84 may be slidably mounted to close compartment 82.

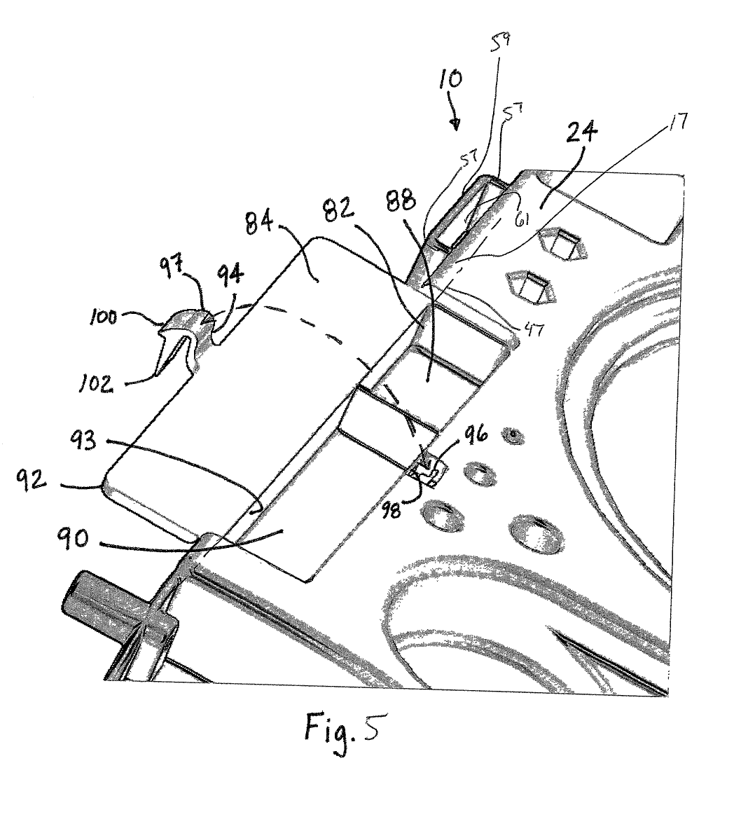

In one embodiment shown in FIG. 5, latch 94 is illustratively C-shaped and is formed from resilient material permitting compression of a C-shaped portion 97 of latch 94. When a user closes lid 84, C-shaped portion 97 is compressed when latch 94 engages latch aperture 96. This arrangement creates tension against latch 94 by opposing side walls 98 of latch aperture 96, holding lid 84 in a closed position over compartment 82.

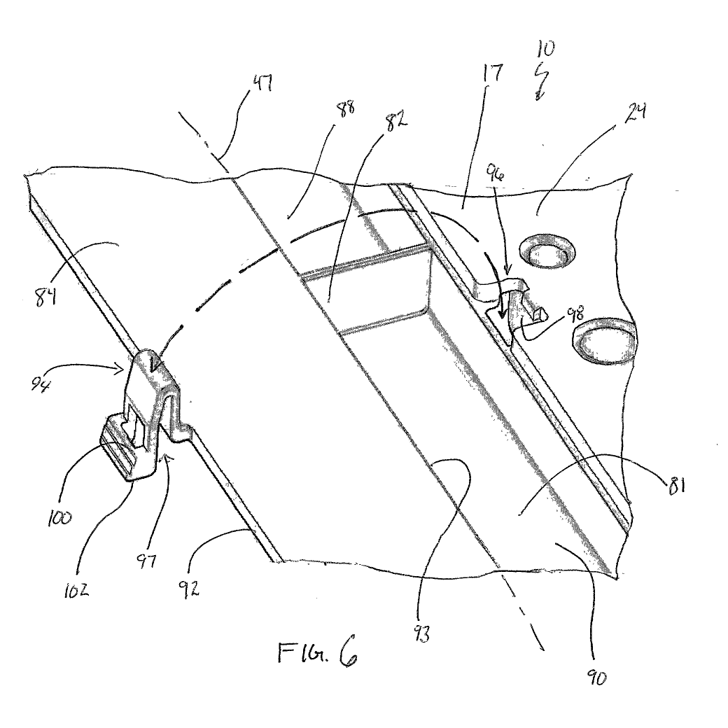

As shown in the alternative embodiments of FIGS. 5 and 6, latch 94 has a lip 100 thereon and latch aperture 96 is formed to include a slot for receiving lip 100 therein to releasably retain latch 94 in latch aperture 96 for closing compartment 82 and positioning lid 84 in the closed position. Illustratively, latch 94 includes a tab 102 to permit a user to release latch 94 from engagement with latch aperture 96. When compartment 82 is closed, tab 102 extends above latch aperture 96 and permits a user to depress tab 102, thereby compressing C-portion 97 of latch 94 to release lip 100 and the remaining portions of latch 94 from latch aperture 96, permitting lid 84 to be pivotably moved to the opened position providing access to compartment 82.

For illustrative purposes, reference is made to FIGS. 3 & 7 to describe one possible configuration and orientation of receptacles 34, 35, 36, 37, 38, and 39. Receptacles 36, 37, and 38 are cylindrically-shaped and provide respective bases. Receptacles 36, 37, and 38 have respective depths 110, 112, and 114 measured from upwardly facing surface 24 to the respective bases. Receptacles 36, 37, and 38 have differing diameters to accept, for example, differing sizes of cylindrical cans (such as paint cans). Receptacle 36 has a diameter greater than the diameter of receptacle 37 and a depth less than the depth of receptacle 37. Receptacle 37 has a diameter greater than the diameter of receptacle 38 and a depth less than the depth of receptacle 38. Receptacle 36 is positioned generally centrally on upwardly facing surface 24. The diameter of receptacle 38 is positioned within the diameter of receptacle 37 and the diameter of receptacle 37 is positioned within the diameter of receptacle 36. This arrangement accommodates, for example, paint cans of varying sizes, without the smaller diameter receptacles interfering with proper receipt of such articles by the larger diameter receptacles.

Receptacle 39 is generally rectangular in shape, is formed in the base of receptacle 36, and is positioned within the diameter of receptacle 36. Receptacle 39 is sized to receive, for example, a small touch-up paint or wall paper roller. Receptacle 35 is an elongated receptacle and is illustratively positioned adjacent rear portion 11 of utility tray 10. Cup holder or cup receptacle 34 is provided by the base of receptacle 35 and is sized to receive, for example, a beverage container or similar article.

Utility tray 10 further includes holes or recesses 40, larger round hole or aperture 42, and corner aperture 44. Comer aperture 44 is provided by upwardly facing surface 24 and is illustratively positioned adjacent front portion 15 and first side portion 17. Upwardly facing surface 24 provides first and second downwardly extending interior walls 51, 53, first wall 51 joining second wall 53 at a side edge of each wall, each of first and second walls 51, 53 being coupled to a curved interior third wall 55 extending between the first and second walls 51, 53. First, second and third walls 51, 53, 55 cooperate to define corner aperture 44 extending through the utility tray 10.

Illustratively, some of holes or recesses 40 are cylindrical, extend through utility tray 10, and are sized to receive, for example, the blade of a screw driver. Further illustratively, other of holes or recesses 40 are hexagonal and provide openings near the upwardly facing surface 24. These other of the holes or recesses 40 terminate at a bottom surface closing the portion of the holes or recesses extending near the downwardly facing surface 25, and are sized to receive, for example, an electric screw driver bit or similarly shaped object. The upwardly facing surface 24 provides the plurality of recesses or holes 40. Each hole or recess 40 illustratively and typically has a depth greater than the distance across the recess measured along a line in a plane coplanar with the portion of upwardly facing surface 24 adjacent the recess. Such illustrative proportions can be appreciated to provide stability to a stored elongated object such as a screw driver.

Further illustratively, round aperture 42 is cylindrical and is sized to receive, for example, the chuck end of a drill or a cordless screw driver. As illustrated in FIG. 3, holes or recesses 40, larger round hole or aperture 42, and corner aperture 44 are positioned on upwardly facing surface 24 and relative to each other and the other features of utility tray 10 so as not to unduly interfere with the use of these other features.

As illustrated in FIGS. 3 and 4, second side 19 includes a trough 46 adjacent second edge 32 and extending along second side 19 between rear and front edges 26, 28. Trough 46 includes a bottom 27 providing a longitudinally extending elongated slot 29. Slot 29 is illustratively sized to receive, for example, the blade of a putty knife or similar object.

As shown in FIG. 5, first side portion 17 includes a pair of spaced apart arms 57 coupled to and extending from first side portion 17. A wall 59 is coupled to and extends between arms 57 to define a space 61 between wall 59 and first side portion 17. Space 61 is sized to receive, for example, a clip on a tape measure, or other similar object.

Although reference is sometimes made in this disclosure to left, right, front and rear orientations, it is within the scope of this disclosure to position the features mentioned in this disclosure on either side or the front or rear of the monolithic body of the utility tray.

Although the invention has been described in detail with reference to preferred or illustrative embodiments, variations and modifications exist within the scope and spirit of the invention as shown and described.

1. A utility tray for a step stool having transversely spaced apart mounting portions, the utility tray comprising:
a molded plastic monolithic tray body having a front portion, a rear portion, opposite side portions, an upwardly facing surface, and a downwardly facing surface,
the rear portion including, at each side portion, a tray mount to engage one of the spaced apart step stool mounting portions for movement about a horizontal axis adjacent the rear portion, and
the front portion including a service cord mount comprising spaced apart recesses opening transversely outwardly.

2. The utility tray of claim 1, wherein the cord mount includes L-shaped extensions coupled to and extending from the front portion, the L-shaped extensions providing the recesses.

3. The utility tray of claim 2, wherein the cord mount further includes a cord clamp coupled to and extending from one of the opposing L-shaped extensions.

4. The utility tray of claim 1, wherein one of the opposite side portions includes a compartment providing a recess in the upwardly facing surface extending along the one of the side portions.

5. The utility tray of claim 4 further comprising a lid hingedly coupled to the utility tray and movable relative to the upwardly facing surface to a position closing the recess.

6. The utility tray of claim 5, wherein the lid includes a latch and the utility tray provides a latch aperture, the latch cooperating with the latch aperture to releasably retain the lid in the position closing the recess.

7. The utility tray of claim 6, wherein the latch includes a lip and the utility tray provides opposing walls defining the latch aperture, the lip engaging at least one of the opposing walls to releasably retain the lid in the position closing the recess.

8. The utility tray of claim 5, wherein the lid and the tray are monolithic to have a monolithic hinge to permit pivoting movement of the lid relative to the upwardly facing surface about an axis defined by the hinge.

9. The utility tray of claim 4 comprising a lid movably coupled to the utility tray and movable relative to the upwardly facing surface to a position closing the recess, and
the other of the opposite side portions includes a trough extending along the previously mentioned side portion.

10. The utility tray of claim 1 comprising a plurality of cylindrical receptacles providing a base and being disposed on the upwardly facing surface of the utility tray and adjacent the rear portion of the utility tray.

11. The utility tray of claim 10, wherein the utility tray provides a first cylindrical receptacle and a second cylindrical receptacle positioned within the first cylindrical receptacle, the first cylindrical receptacle having a diameter greater than a diameter of the second cylindrical receptacle, and the distance from the upwardly facing surface to the base of the first cylindrical receptacle is less than the distance from the upwardly facing surface to the base of the second cylindrical receptacle.

12. The utility tray of claim 10 comprising an elongated receptacle disposed on the upwardly facing surface of the utility tray and positioned between the plurality of cylindrical receptacles and the front portion of the utility tray, the elongated receptacle providing a cup holder therein.

13. The utility tray of claim 1, wherein the upwardly facing surface provides a plurality of holes extending through the upwardly and downwardly facing surfaces.

14. The utility tray of claim 13, wherein at least one of the holes has a diameter larger than the other of the holes.

15. The utility tray of claim 1, wherein the upwardly facing surface provides a plurality of recesses, each recess having a bottom surface and a depth greater than a distance across the recess measured along a line in a plane coplanar with the upwardly facing surface adjacent the recess.

16. The utility tray of claim 1 comprising a pair of spaced apart arms extending from one of the side portions and a wall extending between the arms and defining a space between the wall and the one of the side portions.

17. The utility tray of claim 1, wherein the upwardly facing surface provides first and second downwardly extending interior walls, the first wall joining the second wall at a side edge of each wall, each wall being coupled to a curved interior third wall extending between the first and second walls, the first, second and third walls cooperating to define an aperture extending through the utility tray.

18. A utility tray for a step stool having transversely spaced apart mounting portions, the utility tray comprising:
a molded plastic monolithic tray body having a front portion, a rear portion, opposite side portions, an upwardly facing surface, and a downwardly facing surface,
the rear portion including, at each side portion, a tray mount to engage one of the spaced apart step stool mounting portions for movement about a horizontal axis adjacent the rear portion, and
one of the opposite side portions including a compartment providing a recess in the upwardly facing surface extending along the one of the side portions.

19. The utility tray of claim 18 further comprising a lid hingedly coupled to the utility tray and movable relative to the upwardly facing surface to a position closing the recess.

20. The utility tray of claim 19, wherein the lid includes a latch and the utility tray provides a latch aperture, the latch cooperating with the latch aperture to releasably retain the lid in the position closing the recess.

21. The utility tray of claim 20, wherein the latch includes a lip and the utility tray provides opposing walls defining the latch aperture, the lip engaging at least one of the opposing walls to releasably retain the lid in the position closing the recess.

22. The utility tray of claim 19, wherein the lid and the tray are monolithic to have a monolithic hinge to permit pivoting movement of the lid relative to the upwardly facing surface about an axis defined by the hinge.

23. The utility tray of claim 18 comprising a lid movably coupled to the utility tray and movable relative to the upwardly facing surface to a position closing the recess, and
the other of the opposite side portions includes a trough extending along the previously mentioned side portion.

24. The utility tray of claim 18 comprising a plurality of cylindrical receptacles providing a base and being disposed on the upwardly facing surface of the utility tray and adjacent the rear portion of the utility tray.

25. The utility tray of claim 24, wherein the utility tray provides a first cylindrical receptacle and a second cylindrical receptacle positioned within the first cylindrical receptacle, the first cylindrical receptacle having a diameter greater than a diameter of the second cylindrical receptacle, and the distance from the upwardly facing surface to the base of the first cylindrical receptacle is less than the distance from the upwardly facing surface to the base of the second cylindrical receptacle.

26. The utility tray of claim 24 comprising an elongated receptacle disposed on the upwardly facing surface of the utility tray and positioned between the plurality of cylindrical receptacles and the front portion of the utility tray, the elongated receptacle providing a cup holder therein.

27. The utility tray of claim 18, wherein the upwardly facing surface provides a plurality of holes extending through the upwardly and downwardly facing surfaces.

28. The utility tray of claim 27, wherein at least one of the holes has a diameter larger than the other of the holes.

29. The utility tray of claim 18, wherein the upwardly facing surface provides a plurality of recesses, each recess having a bottom surface and a depth greater than a distance across the recess measured along a line in a plane coplanar with the upwardly facing surface adjacent the recess.

30. The utility tray of claim 18 comprising a pair of spaced apart arms extending from one of the side portions and a wall extending between the arms and defining a space between the wall and the one of the side portions.

31. The utility tray of claim 18, wherein the upwardly facing surface provides first and second downwardly extending interior walls, the first wall joining the second wall at a side edge of each wall, each wall being coupled to a curved interior third wall extending between the first and second walls, the first, second and third walls cooperating to define an aperture extending through the utility tray.

32. A utility tray for a step stool having transversely spaced apart mounting portions, the utility tray comprising:
a molded plastic monolithic tray body having a front portion, a rear portion, opposite side portions, an upwardly facing surface, and a downwardly facing surface,
the rear portion including, at each side portion, a tray mount to engage the spaced apart step stool mounting portions for movement about a horizontal axis adjacent the rear portion,
one of the opposite side portions including a trough extending along the one of the opposite side portions, the trough having a bottom providing a slot extending longitudinally along at least a portion of the trough and through the tray.

33. The utility tray of claim 32, wherein one of the opposite side portions includes a compartment providing a recess in the upwardly facing surface extending along the one of the side portions.

34. The utility tray of claim 33 further comprising a lid hingedly coupled to the utility tray and movable relative to the upwardly facing surface to a position closing the recess.
